(19) United States
(12) Patent Application Publication
(10) Pub. No.: US 2023/0120323 A1
(43) Pub. Date: Apr. 20, 2023

(54) COLLAR ASSEMBLY

(71) Applicant: Innovation Logic Intellectual Property Pty Ltd, Red Hill (AU)

(72) Inventor: Michael O'DARE, Bundall (AU)

(21) Appl. No.: 17/904,192

(22) PCT Filed: Feb. 15, 2021
(86) PCT No.: PCT/AU2021/050130

§ 371 Date: Aug. 12, 2022

(30) Foreign Application Priority Data
Feb. 13, 2020 (AU) 2020900404

(51) Int. Cl. A01M 29/34; E04B 1/72

(52) U.S. Cl. CPC A01M 29/34; E04B 1/72; A01M 2200/011; A01M 1/245

(57) ABSTRACT

The present invention resides in a collar assembly to impede ingress of insects through a concrete slab, the collar assembly comprising two or more base members; and at least one flange member slideably engageable with the two or more base members. The present invention alleviates the problems associated with ingress of insects through a space between pipes and a concrete slab.

### FIELD OF THE INVENTION

The present invention relates to the field of pest control. More particularly, the invention relates to impeding ingress of insects through a concrete slab. Even more particularly, the invention relates to a collar assembly that impedes ingress of termites through a concrete slab.

### BACKGROUND TO THE INVENTION

Any reference to background art herein is not to be construed as an admission that such art constitutes common general knowledge in Australia or elsewhere.

The foundations of a house are an important aspect of many homes as they support the entire structure. One such example of a foundation is a concrete slab. In addition to supporting the structure thereon, concrete slabs also prevent entry of insects (e.g., termites) into the house from the ground. The concrete slab acts as a physical barrier through which the insects cannot eat or burrow.

However, pipes (such as sewage pipes, water pipes or pipes carrying cables) are required to transverse the concrete slab. These pipes can act as a pathway in which insects may enter. In this regard, spaces between the pipes and the concrete slab can act as the pathway in which insects may enter and attack the structure. As such, these pipes and/or critical joints when a concrete slab acts as a physical barrier as per the relevant standards (AS3600) are a weak spot in a concrete slab in preventing access to insects. Presently available solutions can be cumbersome and time consuming to install.

Insects, such as termites, can be extremely destructive to wood and/or cellulose based materials and can compromise the structural integrity of a house. Correcting issues caused by termites can be extremely expensive and disruptive. It would be advantageous to alleviate such issues by preventing access to the insects.

It should be evident that most, if not all, houses built on concrete slabs have pipes which provide an entry point to insects and termites. As such, it would be advantageous to alleviate one or more of the above problems, or at least provide a commercial alternative to the consumer.

### SUMMARY OF THE INVENTION

In a first form, although it need not be the only or indeed the broadest form, the invention resides in a collar assembly to impede ingress of insects through a concrete slab, the collar assembly comprising:
two or more base members; and
at least one flange member slideably engageable with the two or more base members
   wherein one of the at least one flange members secures adjacent base members to one another.

In an embodiment, the base member comprises a first connecting portion. In one embodiment, the first connection portion is a retaining member.

In another embodiment, the at least one flange member comprises a second connecting portion that is complementary to the first connecting portion.

In an embodiment, the second connection portion is a recess.

In certain embodiments, the collar assembly further comprises a locking mechanism.

In an embodiment, one or more of the two or more base members and the at one flange member is/or are formed of, or is/or comprises, insect resistant material.

In one embodiment, the at least one flange member extends outwardly from the two or more base members.

In one embodiment, the collar assembly for use in impeding ingress of insects through a concrete slab. In an embodiment, the collar assembly when used in impeding ingress of insects through a concrete slab. In an embodiment, the insect is a termite.

In a further form, the invention resides in a method of forming a barrier to impede ingress of insects through a concrete slab, the method including the steps of:

locating two or more base members and at least one flange member around a pipe;

engaging the at least one flange member to at least one of the two or more base members;

sliding and rotating the flange member to lock the two or more base members;

to thereby form a barrier to impede ingress of insects through a concrete slab.

The two or more base members and the at least one flange member are as substantially described hereinabove for the first form.

In one embodiment, the method further includes the step of applying an active agent to the pipe. This step is preferably completed prior to locating the two or more base members and the at least one flange member around the pipe.

The various features and embodiments of the present invention referred to in the individual sections above and in the description which follows apply, as appropriate, to other sections, mutatis mutandis. Consequently, features specified in one section may be combined with features specified in other sections as appropriate.

Further features and advantages of the present invention will become apparent from the following detailed description.

### BRIEF DESCRIPTION OF THE DRAWINGS

To assist in understanding the invention and to enable a person skilled in the art to put the invention into practical effect, embodiments of the invention will be described by way of example only with reference to the accompanying drawings, in which:

FIG. 1 shows a base member in slidable engagement with a flange member;

FIG. 2 shows one embodiment of a collar assembly of the present invention in the locked position; and

FIG. 3 shows another embodiment of a collar assembly of the present invention.

### DETAILED DESCRIPTION OF THE INVENTION

Embodiments of the present invention reside primarily in a collar assembly. Accordingly, the collar assembly has been illustrated in concise schematic form in the drawings, showing only those specific details that are necessary for understanding the embodiments of the present invention so as to not obscure the disclosure with excessive detail that will be readily apparent to those of ordinary skill in the art having the benefit of the present description.

In this specification, adjectives such as top and bottom, one or more, and the like may be used solely to distinguish one element or action from another element or action without necessarily requiring or implying any actual such relationship or order.

Words such as “comprises” or “includes” are intended to define a non-exclusive inclusion, such that an assembly or method that comprises a list of elements does not include only those elements but may include other elements not expressly listed, including elements that are inherent to such an assembly or method.

As used herein, the term ‘about’ means the amount is nominally the number following the term ‘about’ but the actual amount may vary from this precise number to an unimportant degree.

As mentioned hereinabove, spaces between pipes and a concrete slab can act as a pathway in which insects may enter and attack the structure of a house. The present invention is predicated on, at least, the finding that a collar assembly can be easily installed or provided to impede ingress of insects between the pipes and the concrete slab.

For ease of description, the collar assembly has been described in relation to an insect. Non-limiting examples of insects include ants and termites. However, it will be appreciated that the collar assembly can be particularly utilized for termites. As such, the term ‘insect’ as used herein may be replaced interchangeably with the term ‘termite’.

In one form, although it need not be the broadest form, the invention resides in a collar assembly to impede penetration of insects through a concrete slab, the collar assembly comprising:
two or more base members; and
at least one flange member slideably engageable with the two or more base members
   wherein one of the at least one flange members secures adjacent base members to one another.

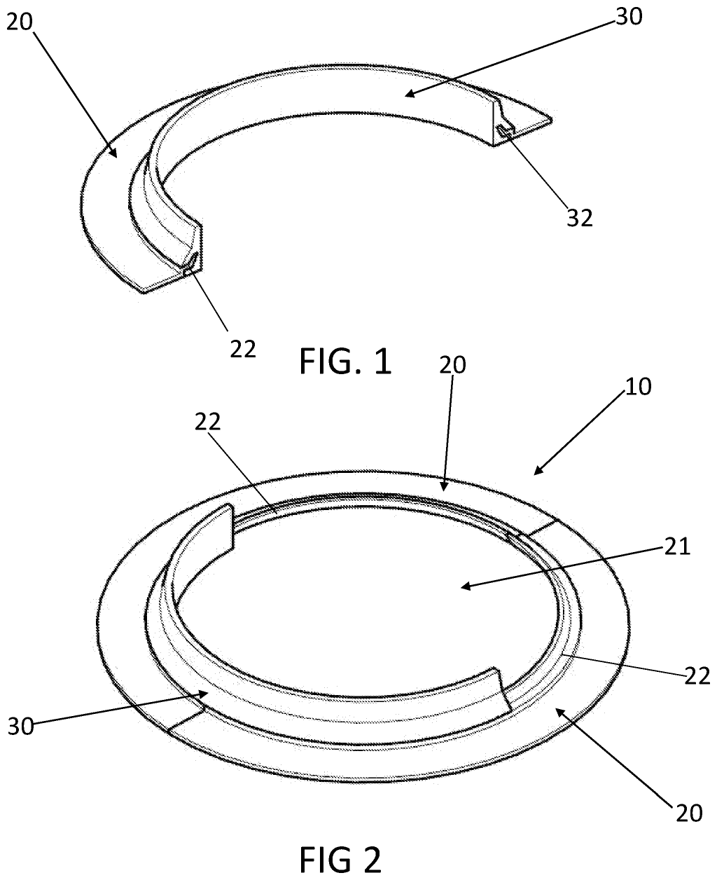

As shown in FIG. 2, the collar assembly (10) comprises two or more base members (20) that together form an aperture (21). The aperture (21) accommodates a pipe (not shown) extending from a house through a concrete slab into the ground. The aperture (21) is generally circular, and each of the base members (20) are generally arcuate in shape. Preferably, each of the base members (20) are substantially semicircular. When each of the base members (20) is semicircular and the number of base members (20) is two, then the aperture (21) has a generally circular shape (as shown in FIGS. 1 and 2). In one embodiment, the collar assembly (10) comprises one, two or three or more base members (20). In certain embodiments, the collar assembly (10) comprises two base members (20). In embodiments, each base member (20) is semicircular in shape.

In one embodiment, the collar assembly comprises n base members; and n-1 flange members slidably engageable with two base members, wherein n is an integer of 2, 3, 4, 5 or greater. In a preferred embodiment, n is 2.

In an embodiment, a flange member of the at least one flange member secure adjacent base members together. In some embodiments, the flange member secures more than two base members together.

In one embodiment, the flange member is rotatable around a central axis of the aperture formed by the base members, such that it secures at least two base members together.

It will be appreciated that the size and dimension of each base member may be selected based on the size of the pipe. Generally, the size of these pipes will be supplied in a few sizes.

Each base member (20) comprises a first connecting portion (22). Preferably, the first connection portion (22) is located on the inner side of the base member (20). The first connection portion (22) extends along the entire inner side of the base member (20). That is, the side closest the aperture (21). The first connecting portion (22) may be any structure that connects to a second connecting portion (mentioned in more detail hereinafter). Non-limiting examples of the first connecting portion (22) include a protrusion or a retaining member. The flange member (30) comprises the second connecting portion. The protrusion or retaining member slideably engages the base member (20) to a flange member (30). That is, the flange member (30) is in slidable engagement with the base member (20). In this regard, the flange member (30) is able to slide relative to the base members (20).

As used herein, the term ‘slidable engagement’ refers to the manner in which the flange member(s) engage the two or more base members. The term ‘slidable engagement’ should also be considered in rotational engagement relative to the longitudinal or central axis of the aperture formed by the base members. In this regard, a flange member is rotated and slid into engagement with two or more adjacent base members.

In the embodiment shown in FIGS. 1 and 2, the first connection portion (22) of base member (20) is in the form of an outwardly extending member. When the first connection portion (22) is engaged with the second connection portion, the flange member (30) extends outwardly from the plane in which the base members (20) reside. In one embodiment, the flange member (30) is generally perpendicular to the base member (20).

As mentioned above, the collar assembly (10) also comprises at least one flange member (30). The at least one flange member (30) comprises a second connecting portion (32) which is complementary to the first connecting portion (22). The second connection portion (32) may be any structure that connects to the first connecting portion (22). Non-limiting examples of the second connecting portion (32) include a recess, an aperture or an indent. As shown in FIG. 1, the second connecting portion (32) is in the form of a recess. In one embodiment, the second connecting portion (32) extends along an entire inner length of the flange member (32). The recess is complementary to the first connecting portion (22) which is in the form of a protrusion. The second connecting portion (32), when connected, is movably engaged to the first connection portion (22) of the base member (20). In one embodiment, the flange member (30) is slidable relative to the one or more base members (20). In other words, the flange member (30) is in a slidable and rotatable engagement in relation to one or more base members (20). It will be appreciated that the first connecting portion (22) and second connecting portion (32) may together include any reciprocal or complementary connecting portions.

When the flange member (30) is engaged to the base member (20), that is when the first connection portion (22) and second connection portion (32) are engaged, then the flange member (30) can be slid and rotated to overlay two base members (as shown in FIG. 2). The person skilled in the art will appreciate that this is the locked position, as the two base members (20) are held in place by the flange member (30). Although FIG. 2 shows a single flange member (30) being utilized, the person skilled in the art will appreciate that more than one flange member can be used. In one embodiment, the collar assembly comprises one or two flange members (30). Preferably, the collar assembly comprises one flange member (30). In a particularly preferred embodiment, the collar assembly comprises a single flange member.

The flange member (30) may comprise a body (34) that extends away from the base member (20), when engaged. The dimensions of the flange member are substantially complementary to the pipe. This body (34) further locates adjacent the pipe and provides a better seal thereto. It is postulated that this further prevents the ingress of insects.

Referring to FIGS. 1 and 2, the body of the flange member (30) locates adjacent a pipe (not shown). In one embodiment, the flange member (30) is arcuate in shape. In an embodiment, the flange member (30) is semicircular in shape.

Given that the first connection portion (22) of the base members (20) are the same, the flange member (30) by virtue of the second connection portion (32) which is complementary to the first connection portion (22) is able to be moved to overlay, and engage, more than one base member (30).

In this regard, as shown in FIG. 1, the first connecting portion (22) and the second connecting portion (32) engage such that only slideable movement is possible. Once engaged, the flange member (30) is only able to slide relative to the base member (20) and is unable to be simply lifted from the base member (20). It will be appreciated that the flange member (30) can only be removed from the base member by sliding it such that it no longer overlays a base member.

In the shown embodiment, the first connecting portion (22) comprises a first vertical extension extending away from the base member (20); a collinear extension extending from the distal end of the first vertical extension, wherein the collinear extension is substantially collinear with the plane of the base member (20); and an end extension extending from the distal end of the collinear extension, wherein the end extension extends at an angle from the collinear extension. The second connecting portion (32) of the flange member (30) comprises the complementary recess to the above. This embodiment of the first connecting portion and second connecting portion prevents the flange member (30) from being simply removed by lifting once engaged with the base member.

The base member(s), and flange member(s) are preferably formed of an insect resistant material. The insect resistant material provides a further deterrent to the insect. In one embodiment, the base members and/or flange member(s) are formed with a coating of insect resistant material. In this embodiment, the base members and/or flange member(s) are formed with an outer coating of insect resistant material. In a further embodiment, the base members and/or flange member(s) comprise an inner body of material. In one embodiment, the inner body is formed of recycled material. In an embodiment, the recycled material is a recycled plastic and/or polymeric material. In a preferred embodiment, the base members and/or flange member(s) comprise an inner body formed of recycled plastic or polymeric material and an outercoating thereover of an insect and termite resistant material (such as a insect and termite repellant) his advantageously allows for the collar to be more environmentally friendly and also commercially viable, whilst still maintaining an insect or termite resistant barrier. In an embodiment, the base members and/or flange members are flexible. In another embodiment, the base members and/or flange members are rigid.

The base member(s) and flange member(s) may also comprise a locking mechanism. The locking mechanism is suitably a compliant mechanism. The locking mechanism ensures that the flange member overlays the base members and is maintained in a locked position. Non-limiting examples of a locking mechanism include a channel and a reciprocal protrusion. For instance, the base member may comprise a channel and the flange member may comprise a protrusion. Alternatively, the base member may comprise the protrusion and the flange member may comprise the channel. The protrusion may have a width that is slightly larger than the width of the channel such that when the protrusion is pushed through the channel, it engages the end of the channel so that it cannot be moved back into the unlocked position without the use of a tool. In one embodiment, the protrusion has a triangular shape. In this regard, a point of the triangular shaped protrusion can be forced through the channel and, once through the channel, a flat side of the triangular shaped protrusion abuts the end of the channel. This prevents the collar assembly from inadvertently moving to the unlocked position and further allows the seal around the pipe to be maintained (mentioned in more detail hereinafter). It will be appreciated by the person skilled in the art that any locking mechanism may be utilized with the collar.

In one embodiment, the base member(s) and flange member(s) may also comprise a first retaining portion that retains the orientation of a flange member relative to base members. The other of the base member(s) and flange member(s) may also comprise a second retaining portion that is complementary to the retaining portion In this regard, one of the base member(s) or the flange member(s) may formed with an integrated gear rack. Preferably, either first connecting portion or the second connecting portion comprises the integrated gear rack. The other of the base member(s) or them flange member(s) comprises a reciprocal ratchet. Preferably, the other of the first connecting portion or the second connecting portion comprises the ratchet. It will be appreciated that once the ratchet engages the integrated gear the base member and flange member are prevented from moving back. The person skilled in the art will appreciate that the integrated gear rack and ratchet is not the only manner in which the orientation and position of the base member and flange member can be retained but merely exemplify one manner in which this is achieved.

In one embodiment, the locking mechanism comprises a first locking mechanism on the base member and a complementary locking mechanism on the flange.

The collar assembly may be disassembled by moving the flange member such that it only overlays a single base member. The remaining base member(s) may be removed, and the flange member may be slid to disengage the base member.

In the embodiment where the collar assembly comprises n base members and n-1 flange members slidably engagement with two base members, wherein n is an integer of 2, 3, 4, 5 or greater, the collar assembly allows for a flange member to be easily located over two base members. In the instance where the number of base members and flange members are equal, it will be appreciated that there may be more resistance to locate the flange members over the base members and that it may be more difficult to fit the flange member over two adjacent base members. The fewer flange member allows for some play in securing and locating them relative to the base members.

One advantage of the collar assembly is that it can be easily installed around the pipes. In this regard, the two or more base member can be easily placed around the pipe and locked into place with the at least one flange member. Generally, the collar assembly should be sufficient to deter ingress of termites and insects.

Further to this, active agent (such as an insecticide or pesticide) may be added to the pipe in which the collar assembly is to be located prior to locking. Non-limiting examples of the active agents include insecticides or termicides. Non-limiting examples of the termicides include fipronil and bifenthrin. In this regard, the locking of the at least one flange member generally brings the base members further together and thus decreases the size of the aperture. This not only forms a better seal, but also forces the active agent to fill voids between the collar assembly, concrete slab and pipes. This provides a further deterrent to the ingress of insects through the concrete slab. In one form, the active agent is in the form of a foam comprising the active agent. The active agent may also include non repellant insecticides and termicides. In this regard, the non-repellant insecticides and termicides may be utilized to prevent other undesirable organisms from entering the structure.

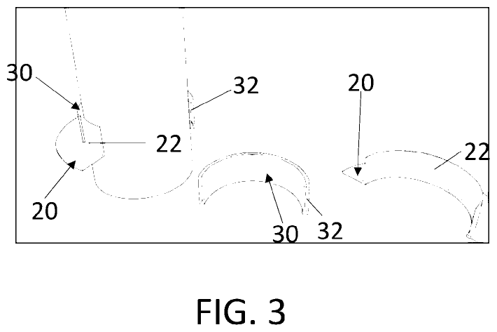

FIG. 3 shows another embodiment of the collar assembly. For ease of description, the same reference numerals have been utilized for the collar assembly 10 described in FIG. 2 and the components thereof. The only significant difference is the first connecting portion 22 and the second connecting portion 32. The first connecting portion 22 comprises a substantially vertical member adapted to be received by a complementary aperture 32. In one embodiment, the second connecting portion comprises the complementary aperture 32. For exemplary purposes the flange member 30 is shown rotated and slid away from the base member 20, in use, the flange member 30 would normally engage an adjacent base member.

In one embodiment, it will be appreciated that the first connecting member and the second connecting member may be interchangeable. In this regard, the base member(s) may suitably comprise the second connecting portion and the flange member(s) may suitably comprise the first connecting portion.

The person skilled in the art will also appreciate that the orientation of the collar assembly may be variable. In this regard, the base member may form an ‘upper end’ of the collar assembly and the flange member may form a ‘lower end’ of the collar assembly. In another embodiment, the base member may form a ‘lower end’ of the collar assembly and the flange member may form an ‘upper end’ of the collar assembly.

In the embodiments shown, the flange member(s) engage the pipe.

However, it will be appreciated by the person skilled in the art that either the base member(s) or the flange member(s) may sealing engage a pipe to prevent ingress of insects.

The person skilled in the art will appreciate that the present collar assembly can be utilized with any pipe known in the art. Non-limiting examples of pipes known in the art are pipes with about 10 mm, about 20 mm, about 30 mm, about 40 mm, about 50 mm, about 60 mm, about 70 mm about 80 mm, about 90 mm, about 100 mm, about 150 mm, about 200 mm, about 300 mm, about 350 mm, about 400 mm, about 450 mm, about 500 mm, about 550 mm, or about 600 mm apertures. It will be appreciated that these types of pipes can have a larger outer diameter. Non-limiting examples of the pipes include pipes with an aperture with a diameter between about 10 mm and about 600 mm, between about 10 mm, and about 500 mm, between about 20 mm and about 400 mm, between about 25 mm and about 300 mm, between about 30 mm and about 200 mm, between about 40 mm and about 100 mm, and between about 10 mm and about 100 mm. It will be appreciated that the pipes may also be electrical conduits.

Non-limiting examples of the outer diameter of the pipes include 21.34 mm (DN 15 mm), 26.67 mm (DN 20 mm), 33.40 mm (DN 25 mm), 48.3 mm (DN 40 mm), 60.3 mm (DN 50 mm), 88.9 mm (DN 80 mm), 114.3 mm (DN 100 mm), 141.3 mm (DN 125 mm), 168.3 mm (DN 150 mm), 219.1 mm (DN 200 mm), 273.0 mm (DN 250 mm), 323.9 mm (DN 300 mm), 355.6 mm (DN 350 mm), and 406.4 mm (DN 400 mm). Non-limiting examples can be found at https://resources.saylor.org/wwwresources/archved/site/wp-content/uploads/2011/07/ME303-4.1.1.pdf which is incorporated herein in its entirety by reference.

In another form, the invention resides in a method of forming a barrier to impede ingress of insects through a concrete slab, the method including the steps of:
locating two or more base members and at least one flange member around a pipe;
engaging the at least one flange member to at least one of the two or more base members;
sliding and rotating the flange member to lock the two or more base members;
to thereby form a barrier to impede ingress of insects through a concrete slab.

The two or more base members and at least one flange member are as substantially described hereinabove.

Depending on the orientation of the collar assembly, either the two or more base members or the at least one flange member may be located first. Once located around a pipe, the at least one flange member is engaged to at least one of the two or more base member, and slid to engage a plurality of base members. This locks the collar assembly in around the pipe.

In one embodiment, the collar assembly may be utilized with a mesh. In one embodiment, the mesh is an extruded mesh. The extruded mesh facilitates integration with a concrete slab. In an embodiment, the method further includes the step of placing a mesh around a pipe prior to locating the base members. In a further embodiment, the collar assembly may be utilized with a vapour barrier. In an embodiment, the vapour barrier may be placed around the pipe and engage the collar assembly. The vapour barrier suitably prevents vapour from passing therethrough. The vapour barrier may also present another barrier towards insects and/or termites from entering the structure.

When assembled, the collar assembly covers any gaps between the pipe and the concrete slab and alleviates the problem of insects using these gaps for entry into the house.

The collar assembly may be utilized with an active agent (mentioned hereinabove). In this regard, the method may further include the step of applying an active agent to the pipe. The active agent may be in the form of a foam. The collar assembly may then be located around the pipe with the active agent therebetween. The collar assembly may then be locked in place. This generally decreases the size of the aperture and forces the active agent to fill the gaps between the collar assembly and the pipe. It will be appreciated that this further prevents the ingress of insects. It will be appreciated that the active agent may be applied to the volume between the collar assembly and pipe after the collar assembly is in place.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1. A collar assembly to impede ingress of insects through a concrete slab, the collar assembly comprising:
two or more base members, wherein each base member comprises a first connecting portion; and
at least one flange member slideably engageable with the two or more base members,
wherein each flange member comprises a second connecting portion that is complementary to the first connecting portion;
wherein rotation of one of the at least one flange members secures the first connecting portion of adjacent base members to the second connecting portion of the flange member.

2. The collar assembly of claim 1, wherein the first connection portion is a retaining member.

3. The collar assembly of claim 1, wherein the second connection portion is a recess.

4. The collar assembly of claim 1, further comprising a locking mechanism.

5. The collar assembly of claim 1, wherein at least, one of the two or more base members and the at least one flange member is formed of insect resistant material.

6. The collar assembly of claim 1, wherein the at least one flange member extends outwardly from the two or more base members.

7. The collar assembly of claim 1 for use in impeding ingress of insects through a concrete slab.

8. The collar assembly of claim 1 when used in impeding ingress of insects through a concrete slab.

9. The collar assembly of claim 1, wherein the insects are termites.

10. The collar assembly of claim 1, wherein the base members and/or flange members is or are formed of an inner body formed of recycled material and an outer coating thereover formed of an insect and termite resistant material.

11. A method of forming a barrier to impede ingress of insects through a concrete slab, the method including the steps of:
locating two or more base members and at least one flange member around a pipe, wherein each base member comprises a first connecting portion, wherein each flange member comprises a second connecting portion that is complementary to the first connecting portion;
engaging the at least one flange member to at least one of the two or more base members; and
rotating one of the flange member such that the second connecting portion thereof secures the first connecting portions of adjacent base members;
to thereby form a barrier to impede ingress of insects through a concrete slab.

12. The method of claim 11, wherein the slide the flange member results in the flange member engaging adjacent base members.

13. The method of claim 11, further including the step of applying an active agent to the pipe.

14. The method of claim 13, wherein the step of applying an active agent to the pipe is before the locating step.
